(19) United States
(12) Patent Application Publication
(10) Pub. No.: US 2026/0113772 A1
(43) Pub. Date: Apr. 23, 2026

(54) OPTIMIZED RESOURCE ALLOCATION FOR CONTAINERIZED APPLICATIONS

(71) Applicant: Boost SubscriberCo L.L.C., Englewood, CO (US)

(72) Inventors: Zeev Vladimir Render, Ashburn, VA (US); Harishankar Menderkar Vinodbabu, Herndon, VA (US)

(21) Appl. No.: 18/919,925

(22) Filed: Oct. 18, 2024

(51) Int. Cl. H04W 72/542; G06F 9/455; H04W 24/08

(52) U.S. Cl. CPC H04W 72/542; G06F 9/455; H04W 24/08; G06F 2009/45595

(57) ABSTRACT

A method is described that includes receiving performance metrics associated with a first application of a plurality of applications running on the containerized mobile network. The first application is deployed on one or more nodes of a first cluster of the containerized mobile network, in accordance with an initial configuration indicative of computational resources allocated to the first application. A performance profile associated with the first application is generated based on the performance metrics. The performance profile defines computational resources to be allocated to the first application based on a current usage of the first application to provide services to subscribers of the containerized mobile network. An instruction can be provided to update the initial configuration for the first application in accordance with the performance profile to adjust the computational resources allocated to the first application according to the performance profile.

### TECHNICAL FIELD

This specification relates to data processing and computing resource allocation.

### BACKGROUND

A mobile network allows devices to stay connected to without being tethered to any wires. Access points amplify network signals, so a device can be far from a router or a cell tower but still be connected to the network. Building and maintaining the network may require hardware and administration tasks to configure and maintain. A cloud computing platform can be used to enhance the capabilities of the mobile network. A cloud-native network function (CNF) is a service that allows operating networks in software, as opposed to specific hardware. The operations can be performed through software and can utilize processing units and memory resources available at the server platform.

### SUMMARY

In a general aspect, a method performed by a computing device and in relation to a network environment is provided. In some implementations, the method can be executed at a cloud-network orchestrator unit and within the network environment. The method includes receiving, at one or more computing devices controlling nodes running in clusters on a containerized mobile network, performance metrics associated with a first application of a plurality of applications running on the containerized mobile network. The first application can be deployed on one or more nodes of a first cluster of the containerized mobile network in accordance with an initial configuration indicative of computational resources allocated to the first application. The method further includes generating, based on the performance metrics, a performance profile associated with the first application, the performance profile defining computational resources to be allocated to the first application based on a current usage of the first application to provide services to subscribers of the containerized mobile network. The method further includes providing, by the one or more computing devices, an instruction to update the initial configuration for the first application in accordance with the performance profile to adjust the computational resources allocated to the first application according to the performance profile.

Implementations of the method can include one or more of the following features. The generation of the performance profile associated with the first application can include determining computational resources required by each of a plurality of components of the first application based on the current usage of the first application. Each component can be deployed and can run on a node of the one or more nodes of the first cluster associated with the first application. The generation of the performance profile can include defining the performance profile for the first application for adjusting the computational resources allocated to each component in accordance with the required computational resources as determined.

In some implementations, the method further includes determining, by the one or more computing devices, available computational resources at a first node to be allocated to another component of an application of the plurality of applications. In response to determining the available computational resources at the first node, identifying, by the one or more computing devices, a component of the application to be scheduled for deploying on the first node to consume at least some of the available computation resources as determined to be allocated to the other component. In some implementations, the method further includes sending instructions to remove the component from a second node of the first cluster of the containerized mobile network. Instructions can be sent to deploy the component on the first node. The component can be deployed on the first node according to a current configuration of the application including the component. The current configuration of the application includes a performance profile of the component defining computational resources to be allocated to the component of the application by the first node.

In some implementations, the identified component to be scheduled for deploying on the first node can be of the first application, and the current configuration for the component can define the computational resources to be allocated to the component in accordance with the current usage of the first application. In some implementations, the identified component can be of a second application being deployed and running at the first cluster. In some cases, the first and the second application can include components deployed on the same first node of the first cluster.

In some implementations, the method can include continuously monitoring and evaluating the performance metrics of the first application while running on the containerized mobile network. The method can further include iteratively generating one or more subsequent performance profiles associated with the first application to generate configurations to be used for updating the first application. The generated configurations are to be applied to adjust the computational resources allocated to the first application in accordance with the current usage of the first application as determined based on the continuous monitoring and evaluation of the performance metrics of the first application. The configurations can be indicative of computational resources to be allocated to the first application as defined with a respective performance profile.

In some implementations, the computational resources provided by the one or more nodes of the first cluster include CPU and memory resource.

In some implementations, each cluster on the containerized mobile network comprises a set of nodes that run containerized applications. Each cluster can run a networking application deployed on at least one node of the respective cluster. The networking application encapsulates physical and virtual resources.

In some implementations, the method can include persisting one or more latest-used configurations for the first application while monitoring the performance metrics of the first application running on the containerized mobile network.

The present disclosure further provides a system for implementing the methods provided herein. The system includes one or more processors and a computer-readable storage medium coupled to the one or more processors, having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

Various implementations of the technology described herein may provide one or more of the following advantages.

In some cases, the technology described herein can enable efficient data processing for determining distribution of computational resources in an optimal way that is tailored to the current usage. Applications can provide services to subscribers of a containerized mobile network where the consumption of resources provided by the underlying hardware infrastructure may vary based on the actual usage of the applications. By dynamically tailoring the allocation of computational resources to applications based on tuning to the actual consumption to provide steady performance of the applications, the underlying infrastructure is used more efficiently, and fewer resources are spent for maintaining the services compared to cases where resources are distributed according to a fixed schema of resource distribution. Performance profiles can be refined over iterations for the applications so that an optimal performance profile is determined and user to optimize the deployment of applications at various nodes at clusters of the containerized environment.

The details of one or more implementations of the present disclosure are set forth in the accompanying drawings and the description below. Other features and advantages of the description will become apparent from the following description and from the claims. Unless otherwise defined, the technical and scientific terms used herein have the same meaning as commonly understood by one of ordinary skill in the art to which this invention belongs.

### BRIEF DESCRIPTION OF THE DRAWINGS

FIG. 1A is a diagram of an example of a network environment and a user-device connected to the exemplary network environment.

FIG. 1B is a diagram of an example of a virtual network environment including a cloud-native mobile network.

FIG. 2 is a flowchart of an example of a process for providing instructions for updating a configuration of an application in accordance with monitored performance metrics.

FIG. 3 is a block diagram of an example network for managing resource allocation to services running in containerized mobile network.

FIG. 4A is a block diagram of an example cluster running with an initial configuration at a containerized mobile network.

FIG. 4B is a block diagram of the example cluster of FIG. 4A running with an updated configuration to optimize resource allocation.

FIG. 5 is a diagram illustrating an example of a computing environment.

### DETAILED DESCRIPTION

The technology described herein relates to allocating resources for applications and/or services running in a containerized mobile network so that the resources are distributed according to their expected consumption and optimized to support efficient performance without wasting resources that are not used. Requirements for applications (e.g., providing 5G network functions) running at a mobile network (e.g., a 5G network) can be defined as part of a configuration of the applications and the applications' artifacts. In some instances, the requirements for the applications running on the containerized mobile network can be defined based on an expected number of consumers (e.g., subscribers) for the applications so that a targeted service level is met, and subscribers do not experience downtime. In some instances, a configuration for the allocated resources, such as CPU and memory, to be provided to an application can be fixed based on predefined requirements that may or may not track the actual utilization of resources. In some cases, the allocation of resources may not be as optimal, even if it achieves a required performance for the end users, e.g., no downtime, since the resources may be overspent for the applications. For example, more resources may be allocated to an application compared to the resources that are actively used. In some instances, such resources that are not actively used cannot be used by other applications that may, for example, run in situations where resources are scarce and services may be delayed. Allocation of resources based on monitored performance for the consumption of resources by applications can support optimized resource distribution compared to the resource distribution that can be achieved if the allocation of resources is preconfigured and maintained over time without adjustments based on runtime monitoring of the applications.

For example, the actual number of consumers of an application at runtime can differ from the expected number of consumers or may vary over time (e.g., not a stable requirement). Therefore, configuring requirements for the application may be dynamically modified or adjusted based on input obtained from the monitored performance of the application. In such a manner, the allocated resources for the application can be determined based on the monitored performance of the application, and dynamic adjustments can be made to tailor the allocation to the needs. Such dynamic adjustments can be performed by updating the configuration of the application and modifying the system requirements based on obtained performance metrics during monitoring of the application.

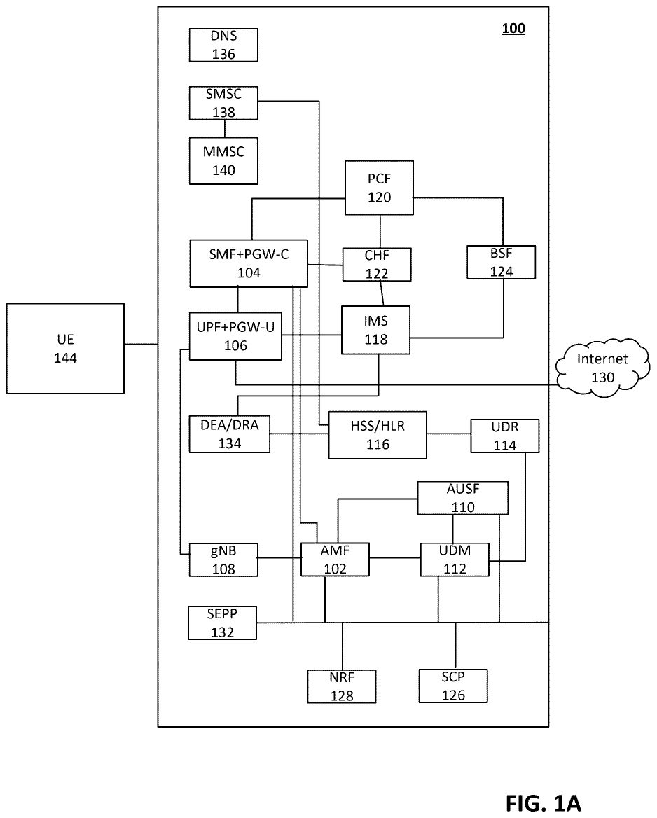

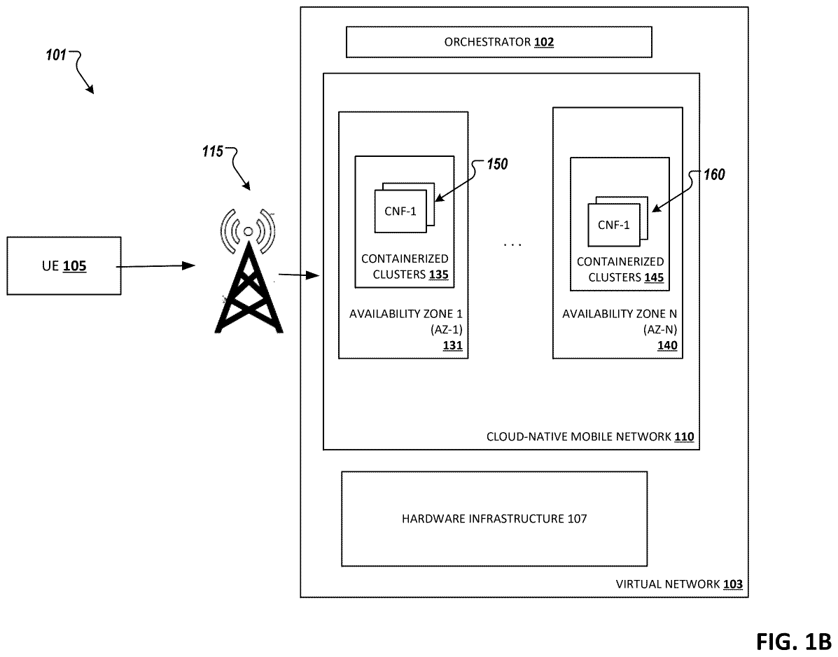

FIG. 1A depicts a diagram of an exemplary network environment 100 and a user equipment (UE) device 144 connected to the exemplary network environment. As used herein, a network environment (sometimes referred to herein simply as an environment) refers to a set of multiple devices, modules, and functions that are configured to jointly enable wireless communication. For example, a network environment can include a 5G network that includes a set of multiple devices, radio access network (RAN)/core network functions, and application functions that are configured and integrated to jointly enable wireless communication. In some instances, the network may be a hybrid cellular network that includes a physical RAN and relies on a cloud computing platform to host various network functions (NF), such as core network functions.

An environment, such as the environment 100, can be a portion of a 5G New Radio (“5G-NR” or simply “5G”) cellular network environment. Standards for cellular network architectures have previously been described, for example, in 3GPP TS 23.501 (for 5G networks) and 3GPP TS 23.401 (for 4G long-term evolution “LTE” networks) (the entireties of which are hereby incorporated by reference). While FIG. 1 shows an exemplary architecture for a network environment (i.e., environment 100), it is not intended to be limiting. The lines depicted in FIG. 1, that connect network elements are indicative of the possibility of direct communication between those network elements.

Network environment 100 includes a packet core network, which includes an access management function (AMF) 102, a session management function and packet data network gateway-control module (SMF+PGW-C) 104, a user plane function and packet data network gateway-user plane module (UPF+PGW-U) 106, and a policy control function (PCF) 120. The AMF 102 receives all connection and session related information from one or more user equipment (UE) devices 144, and manages connection and mobility management tasks. The AMF 102 forwards all messages related to session management to the SMF+PGW-C module 104. The SMF+PGW-C module 104 and UPF+PGW-U module 106 jointly manage sessions and are configured using Control and User Plane Separation (CUPS). The PCF 120 communicates with the SMF+PGW-C module 104, governing control plane functions via defined policy rules. The UPF+PGW-U module 106 can provide access to the Internet 130 for data applications and the IP Multimedia Subsystem (IMS) core module 118 for voice applications. The IMS core module 118 is a separate application core network from the packet core network and supports voice services, messaging, voice calls, etc.

The environment 100 can further include a charging function (CHF) 122 and a binding support function (BSF) 124. The CHF 122 supports online and offline charging features and completes billing functions. The BSF 124 tracks sessions that are located anywhere in the environment 100, but share common criteria, such as subscriber identifiers. The BSF 124 communicates with the PCF 120 and binds application-function requests to specific PCF instances, enabling policy scaling of the environment 100.

The environment 100 also includes a gNB 108 (i.e., a 5G base station), which handles run-side aspects of the network environment 100 and communicates, either directly or indirectly, with the packet core network elements such as AMF 102, SMF+PGW-C module 104, and UPF+PGW-U module 106.

The environment 100 further includes network elements to manage user or subscriber information. For example, the environment 100 includes an authentication service function (AUSF) 110 for user authentication and a unified data management (UDM) module 112. The user database is stored in a unified data repository (UDR) 114. The UDM 112 communicates with the AMF 102, AUSF 110, and the UDR 114 to provide centralized control of network user data. For interworking with 2G, 3G, and 4G network elements, the environment 100 also includes a Home Subscriber System and Home Location Register (HSS/HLR) module 116, which stores subscriber information, location, SIM details, and authentication keys.

The environment 100 further includes a service communication proxy (SCP) 126 and a network repository function (NRF) 128. In accordance with current 5G standards, network functions are based on HTTP version 2, and use the SCP 126 and NRF 128 to communicate. The NRF 128 is used to discover network functions in the environment 100, and the SCP 126 is used to provide a single point of entry for a cluster of discovered network functions, serving as a central control point in the signaling network core.

The environment 100 further includes a security edge protection proxy (SEPP) 132, a diameter edge agent, a diameter routing agent (DEA/DRA) module 134, and a domain name system (DNS) 136. The SEPP 132 is a security proxy through which all signaling traffic across operator networks is expected to transit. The DEA/DRA module 134 manages traffic and congestion of messages routed across the environment 100, routing signaling traffic and performing load balancing, relay, proxy, and redirect functions within a carrier or interworking with other carriers. The DNS 136 is a naming database in which internet domain names are located and translated into internet protocol (IP) addresses.

The environment 100 further includes a short message service center (SMSC) 138 and a multimedia message service center (MMSC) 140 configured to receive, store, route, and forward SMS messages and MMS messages, respectively.

The network environment 100 can be configured to interact with external systems. In some implementations, the external systems can include another network such as a 4G or 5G roaming partner network. For example, the environment 100 can interact with a roaming partner network using an IP Packet eXchange (IPX) telecommunications interconnection model provided between the two network environments. In other examples, the environment 100 can interact directly with the roaming partner network environment without an IPX provider in between the two networks.

In some implementations, the external systems can include a message aggregator configured to aggregate messages and route a portion of the aggregated messages to the environment 100. For example, the aggregated messages can be SMS or MMS messages.

The UE 144 can interact with the network environment 100 indirectly through the external systems or directly with the network environment 100 (e.g., via the gNB 108). In some cases, the UE 144 can be a subscriber to the network environment 100 (e.g., a subscriber to a service provider of the cellular network). In other cases, the UE 144 can be a non-subscriber roaming on the network environment 100.

FIG. 1B is a diagram of an example of a virtual network environment 101 including a cloud-native mobile network 110. The virtual network environment 101 can include user equipment 105, structure 115, and a virtual system 103 to host different services and applications that implement the functionality provided by various components of the virtual system 103. The virtual network environment 101 is implemented as a hybrid mobile networks environment that includes specialized hardware 107 to host a cloud platform where virtualized mobile network components that form the cloud-native mobile network 110. For example, the cloud platform that can be used for hosting the cloud-native mobile network 140 can be an Amazon Web Services (AWS).

UE 105 can represent various types of end-user devices, such as mobile phones, smartphones, cellular devices, etc. The structure 115 can be any structure to which an antenna can be attached. The structure 115 can be dedicated cellular towers, a building, a tower, or other structures that can allow antennas to be mounted and network resources to be provided to a covered geographical area.

In a virtualized arrangement, specialized software running on hardware may be used to perform functions such as the AMF 102, the SMF+PGW-C 104, the UPF+PGW-U 106, the PCF 120, the CHF 122, the BSF 124, or the NRF 128 as described in relation to FIG. 1A. The functionality of such functions can be distributed to physical server systems that may or may not be co-located.

In some implementations, some functions in the virtual system 103 can be executed at a same data center, while other functions may be executed at separate data centers or on separate cloud platforms. The cloud-native mobile network 110 can be executed over a cloud platform that can be a third-party cloud-based computing platform or a cloud platform operated by the same entity as operating the virtual system 103. The cloud-native mobile network 110 can provide hardware resources to cloud-based applications (e.g., network components).

The cloud-native mobile network 110 can be used to create, manage, and maintain 5G core components (units or subunits) needed for providing a mobile network that is functional and operational. In some instances, the cloud-native mobile network may be configurable to add more instances of applications and services if network traffic increases without adding additional hardware. The instances of the 5G core components can be created and managed in a containerized setup, for example, by using Kubernetes, Docker, or another container orchestration platform.

The cloud-native mobile network 110 can be managed by an orchestrator 102. The orchestrator 102 can represent a logical component that is executed at the underlying hardware 107 and is implemented to perform monitoring and management of the cloud-native mobile network 110. In some instances, the orchestrator 102 can be configured to monitor network traffic associated with functions provided by the cloud-native mobile network 110. The orchestrator 102 can allow for the instantiation of applications in availability zones on the cloud-native mobile network 110. For example, the orchestrator 102 can instruct to instantiate a new cloud component (e.g., an application or service), at one or multiple zones of the “Availability zone 1” 131 to “Availability zone N” 140. In some cases, the availability zones (“Availability zone 1” 131 to “Availability zone N” 140) can be distributed over one or more data centers at one or multiple locations to provide service coverage at a designated area. Cloud-based components can be instantiated by loading respective source code for a component, creating clusters, and loading containers to provide a respective function.

In some instances, an availability zone at the cloud-native mobile network can support the execution of applications over clusters (e.g., Kubernetes clusters) that allow containers to run across multiple machines (e.g., virtual machines, physical machines, cloud based, server based, etc.). A cluster can be considered as a set of nodes (e.g., virtual machines) that run containerized applications. When an application is containerized, the application is packaged with the application dependences and necessary services in a container so that it is lightweight and flexible compared to virtual machines as it is easier to develop, instantiate, and manage compared to other cloud computing techniques. Containerization provides tools and techniques to pack small units or components (e.g., microservices) into a deployable package that can run on different platforms.

The containerized environment provided as part of the cloud-native mobile network 110 includes nodes as units of computing hardware, such as a virtual machine or a physical machine in a database. The containerization allows insertion to a level of abstraction so that each node is viewed as a machine providing computing resources, such as a set of CPUs and RAM resources that can be utilized by applications running in this containerized environment.

In containerized environments, programs (such as applications, artifacts, components, services) running on a cluster, are not limited to run on a specific node, and can be saved at arbitrary places in the file system, and does not have to be maintained as stored and running in the originally stored position. The computing resources, such as CPU and RAM resources of all nodes allocated to a cluster are managed together as part of the management of the cluster.

When programs are executed in a containerized environment, the programs are packaged as containers that can be deployed. As such, an application that runs on a cluster of the containerized clusters 135 of “availability zone 1” 131 can be deployed as a container to run and provide services to end users or other services/applications. In some instances, multiple programs can be added into a single container, however some containers may be defined for the execution of a single process. Pods can be defined as a basic unit of computation that is defined in a containerized environment for software deployment, scaling, and management, such as Kubernetes. A group of pods, related or unrelated, can run on a cluster. In some instances, one or more containers can be combined in a pod to share the same resources and network. The cloud-native mobile network 110 can support the direct deployment and management of pods, rather than working with containers. The orchestrator 102 can monitor and manage the software deployment process and provide software management tools and techniques to provide services through executed containerized applications that meet predefined service-level criteria. When containerized applications are deployed on a cluster of the cloud-native mobile network 110, a set of pods defined for an application can be provided for deployment. The deployment process can determine or declare how many instances of a pod should be instantiated to run at the same time. The number of instances may be associated with an expected processing load associated with the programming code of that pod.

In some instances, mobile network functions can be executed by combining network services and running them in a containerized environment, such as the cloud-native mobile network 110 so that network services are distributed across the network 110, for example, depending on where the services are needed. As such, pods can be deployed on a cluster of nodes of the cloud-native mobile network to form an application and/or service, for example, as a service that performs network service tasks in software instead of through specific hardware.

The “Availability zone 1” 131 of the cloud-native mobile network 110 includes containerized clusters 135 where applications can run. For example, cloud-native functions (CNF) applications 150 or other applications/services (not shown). The “Availability zone N” 140 of the cloud-native mobile network 110 includes containerized clusters 145 where applications can run, for example, CNF applications 160 or other applications/services (not shown). A set of nodes can be considered to form a cluster that provides resources for deploying programs on a cluster. In cases where the set of nodes is modified to add or remove some of the nodes, the cluster can continue to function however the execution will be shifted over more or less nodes as modified.

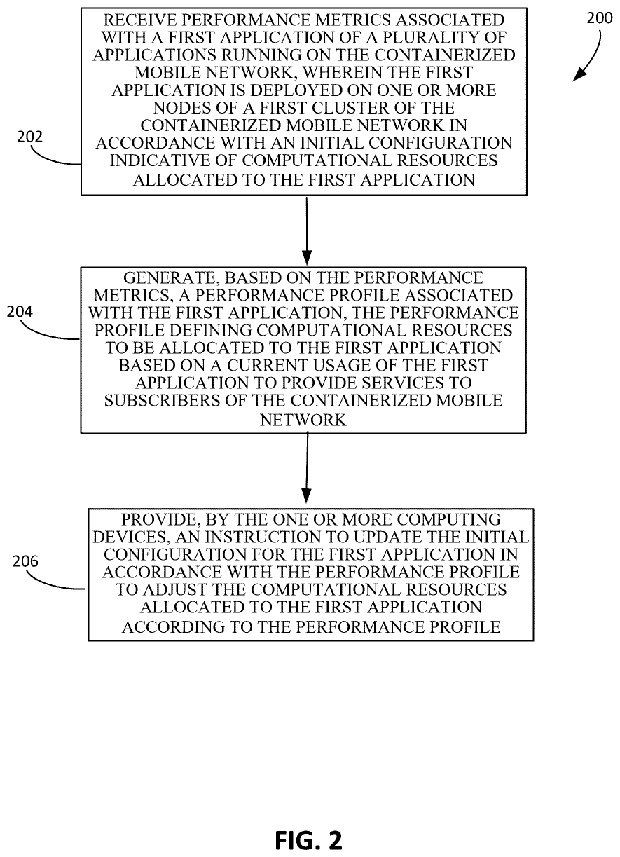

FIG. 2 is a flowchart of an example of a process 200 for providing instructions for updating a configuration of an application in accordance with monitored performance metrics. The application can be executed on a containerized mobile network, such as the cloud-native mobile network 110 of FIG. 1B. The operations of the process 200 can be executed by an orchestrator 102 of FIG. 1B.

Operations of the process 200 include receiving performance metrics associated with a first application of a plurality of applications running on the containerized mobile network. The performance metrics can be received at one or more computing devices controlling nodes running in clusters on the containerized mobile network. For example, the one or more computing devices controlling the nodes can be computing devices including an orchestrator to manage the deployment and maintenance of applications on the containerized mobile network. For example, the orchestrator can be substantially similar to the orchestrator 102 of FIG. 1B. The first application is deployed on one or more nodes of a first cluster of the containerized mobile network, in accordance with an initial configuration indicative of computational resources allocated to the first application (202). For example, the nodes can provide computing resources that can be consumed by applications and services run on the network.

As discussed in relation to FIG. 1B, the containerized mobile network can include multiple clusters, where each cluster can include a set of nodes that run containerized applications, wherein each cluster runs a networking application deployed on at least one node of the respective cluster. The networking application encapsulates physical and virtual network resources.

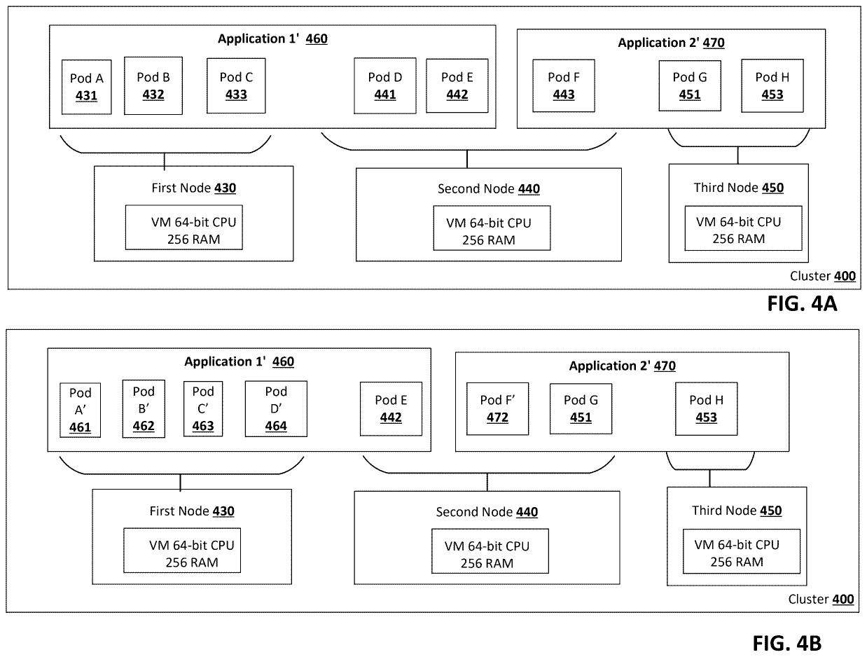

Operations of the process 200 also include generating, based on the performance metrics, a performance profile associated with the first application, the performance profile defining computational resources to be allocated to the first application based on a current usage of the first application to provide services to subscribers of the containerized mobile network (204). In some instances, the generated performance profile can be a profile that can modify a distribution of components (or pods) through nodes of a cluster, for example, to modify a configuration of the pods on nodes as described in relation to FIG. 4A, where the performance profile determined at 204 can result in a deployment that can be for example as the modified configuration in FIG. 4B, where at least one component is redeployed to another node based on modifying the allocated computational resources to the “Application 1” as shown in FIG. 4A. The computational resources provided by nodes of a cluster include CPU and memory resources.

Optionally, operations of the generation of the performance profile can include determining computational resources required by each of a plurality of components of the first application based on the current usage of the first application and defining a performance profile for each of the plurality of components adjusting the computational resources allocated to each component in accordance with the required computational resources as determined. Each component can be deployed and can run on a node of the one or more nodes of the first cluster associated with the first application. The component of the application can be substantially similar to a pod, where multiple pods form an application, and one or more pods of applications can run at a cluster, for example, as described in more detail in relation to FIGS. 4A and 4B.

Operations of the process 200 further include providing, by the one or more computing devices, an instruction to update the initial configuration for the first application in accordance with the performance profile to adjust the computational resources allocated to the first application according to the performance profile (206).

Optionally, operations of the process 200 can also include determining available computational resources at a first node, to be allocated to another component of an application of the plurality of applications. The process 200 can further include that in response to determining the available computational resources at the first node, a component of the application is identified to be scheduled for deploying on the first node to consume at least some of the available computation resources as determined to be allocated to the other component.

The process 200 can also include sending i) instructions to remove the component from a second node of the first cluster of the containerized mobile network and ii) instructions to deploy the component on the first node, wherein the component is deployed on the first node according to a current configuration of the application including the component. The current configuration of the application can include a performance profile of the component defining computational resources to be allocated to the component of the application by the first node.

In some examples, the component can be a component of the first application, and the current configuration for the component can define the computational resources to be allocated to the component in accordance with the current usage of the first application. For example, the component can be pod D 441 of “Application 1” 410 of FIG. 4A that can be removed from the second node 440 and deployed at the first node 430 upon determining that there are available computational resources at the first node 430. For example, the determination of available computational resources can be based on evaluating the performance of the pods running on a given node to determine whether they use the resources allocated to them. In some cases, if after evaluation of the available resources based on applying the performance profiles, it is determined that the first node 430 (or any other node currently running as part of the cluster) does not have enough free resources (within the available threshold to be allocated for new components or pods), the component may be maintained at the second node of the first cluster. In some instances, a subsequent evaluation for available resources can be performed, for example, within a predefined time or according to an evaluation schedule, and at a subsequent iteration, another node that has enough available resources can be identified. Accordingly, instructions to remove the component from the second node can be sent so that the component is executed on the other node identified during the subsequent iteration.

In some examples, components may not be moved between nodes even after applying performance profiles and adjusting the resources allocated to running components at one or more of the nodes. This can take place, for example, to optimize the usage of resources for running instances without reducing the number of nodes used in the network. In some implementations, when a new application is to be deployed, an available node of the network may be identified based on availability of resources for the new application. If such a node is not available, a new node may be instantiated in the network to run the new application.

In some examples, the component that is identified to be scheduled for deployment on the first node can be a component of a second application being deployed and running at the first cluster. The first and the second application can include components deployed on the same first node of the first cluster. For example, the second application can be such as the “Application 2” 420 of FIG. 4A that includes pods that run on the second node 440 and the third node 450. The component that can be identified to be scheduled for deployment can be, for example, pod F 443 of “Application 2” 420 of FIG. 4A that can be redeployed on the first node 430, if it is determined that the pods running on the first node can be reconfigured to be allocated with resources that allow for the pod F 443 to be added to the node and still be provided with the required resources for the pod F execution. The determination of the configuration of the profile for pods on a cluster can be based on considering the current usage of an application so that computational resources are adjusted according to a defined performance profile of an application. The performance profile of an application can define the resources to be allocated to pods within the application based on obtained performance metrics with that application, for example, at the orchestrator of the network where the applications are running.

Optionally, the process 200 can include continuously monitoring and evaluating the performance metrics of the first application, while running on the containerized mobile network and iteratively generating one or more subsequent performance profiles associated with the first application to generate configurations to be used for updating the first application, thus to adjust the computational resources allocated to the first application in accordance with the current usage of the first application as determined based on the continuous monitoring and evaluation of the performance metrics of the first application. The configurations can be indicative of computational resources to be allocated to the first application as defined with a respective performance profile.

Optionally, the process 200 can include persisting one or more latest-used configurations for the first application while monitoring the performance metrics of the first application running on the containerized mobile network.

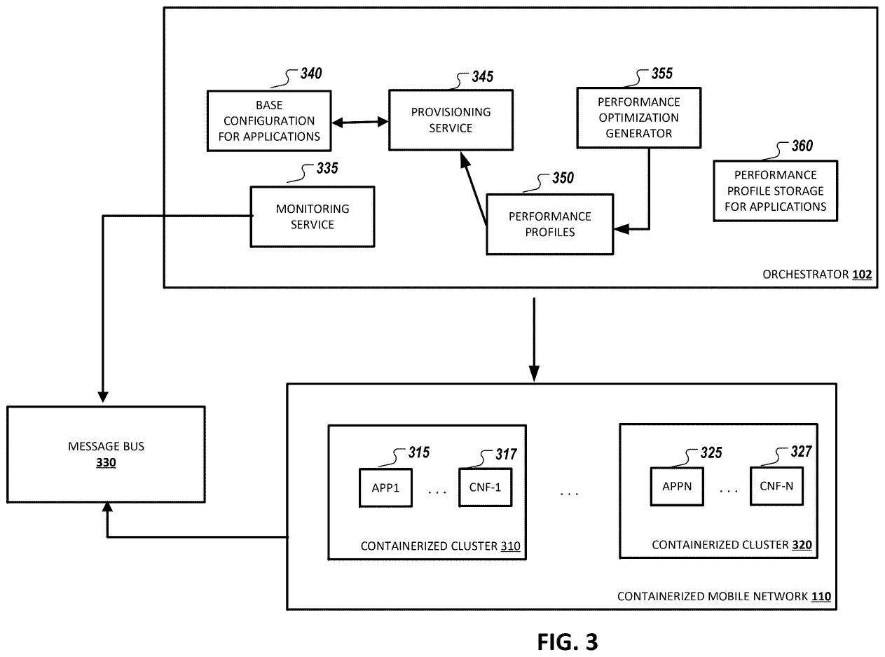

FIG. 3 is a block diagram of an example network 300 for managing resource allocation to services running in a containerized mobile network. The example network 300 can substantially correspond to the virtual network 103 of FIG. 1B. The network 300 includes a containerized mobile network 110 such as the containerized mobile network 110 of FIG. 1B.

The containerized mobile network 110 includes a set of containerized clusters including containerized cluster 310 and containerized cluster 320. The containerized clusters are hosted over nodes that provide computing resources for deploying and managing applications. A set of nodes can be considered to form a cluster that provides resources for deploying programs on a cluster.

A containerized application, such as APP1 315, CNF-1 317, APPN 325, CNF-N 327, can be defined to include a set of pods that can be provided as a group for deployment at a cluster, such as the containerized cluster 310 or containerized cluster 320. The containerized mobile network 110 can support the direct deployment and management of pods, where an orchestrator 102 can monitor and manage the software deployment process and provide software management tools and techniques. When containerized applications are deployed on a cluster of the containerized mobile network 110, a set of pods defined for an application can be provided for deployment. Turning to FIG. 4A, a set of pods including pod A 431, pod B 432, pod C 433, pod D 441, and pod E 442 can be pods part of “Application 1” 410, which are deployed on nodes provided for the respective cluster 400. The application can be deployed according to an initial base configuration that defines an allocation of the resources provided by the nodes to each of the pods. For example, each pod of the set of pods of “Application 1” 410 of FIG. an application and/or service, for example, as a service that performs network service tasks in software instead of through specific hardware. The initial configuration may be defined based on the type of the application, for example, the services provided. When an application is deployed, and application can be deployed with multiple instances, where for one or some of those instances the initial configuration can be applied. During monitoring of the performance of various instance of an application, a performance profile to modify the configuration and the allocated resources can be generated for one of the instances, which may be applied to that instance and may or may not be applied for other running instance.

In some instances, applications that run on the containerized clusters 310 to 320 can include cloud-native network functions, for example, 5G applications. The applications are deployed to run on the underlying hardware infrastructure according to a defined state including their configuration. The deployment process at the containerized environment can be managed by the orchestrator 102. The orchestrator 102 can be substantially similar to the orchestrator of FIG. 1B and can provide services to organize and manage the deployed entities by supporting interoperability and relying on interfaces to communicate with other entities in the network 300 and rely on virtualization technologies. The orchestrator 102 can include multiple components that support the provisioning of applications and/or services, the monitoring of the performance of these applications and/or services and managing the configuration so that it is aligned with the current usage of resources by the applications and/or services to provide improved performance while optimizing the resource expenditures.

The orchestrator includes a provisioning service 345 that can obtain configuration data for provisioning new instances of applications, for example, the base configuration for applications 340 storage. The provisioning service 345 can use the base configurations as defined for deploying and starting the instance of applications at the containerized mobile network 110. The orchestrator 102 includes a monitoring service 335 that can obtain performance metrics for the execution of applications at the containerized mobile network 110. The monitoring service 335 can obtain the performance metrics through a message bus 330. The message bus 330 can be a universal message bus that facilitates asynchronous communication between applications through reliable and guaranteed messages delivery and receipt process. The orchestrator 102 can subscribe to obtain messages from the message bus 330 that can include data related to the containerized mobile network 110. The containerized mobile network 110 can be a producer of data that is posted as messages to the message bus 330. For example, the containerized mobile network can post data related to a predefined topic, e.g., performance metrics such as metrics for consumed computational resources over time, onto the message bus 330, e.g., based on a predefined time schedule. For example, the data can be posted daily, weekly, or based on another time schedule with regular or irregular time intervals. In some examples, the data can be posted based on identified events at the containerized mobile network 110 so that data can be pushed outside of a predefined time pattern for posting data. Upon posting of data (i.e., through messages) by clusters of the containerized mobile network 110 at the message bus 330, the orchestrator 102 can obtain such data when the orchestrator 102 is subscribed for such data (e.g., subscribed to the topic of the data, or the type of the data, among other manners of defining the scope of the data for which a subscription is made).

When the monitoring service 335 obtains data about the performance of clusters at the containerized mobile network 110, the obtained data can be evaluated and performance metrics can be determined for one or more applications running in the containerized mobile network 110. Since each application running on clusters of the containerized mobile network 110 may be deployed on one or more nodes of a given cluster, applications may be spread through nodes, for example, as shown on FIG. 4A. The applications can be instantiated at the clusters based on base configurations obtained by the provisioning service 345, and when performance metrics for the performance of the applications are received at the monitoring service, performance profiles for each of the applications can be defined.

In some instances, performance profiles 350 for one or more of the applications running on the containerized mobile network 110 can be generated, at a performance optimization generator 355, as described in relation to operation 204 of FIG. 2. Computational resources required by each component of an application can be determined based on the obtained measurement for the performance. The measurements may indicate what is the current usage of a given application and this usage can be compared with the allocated resources (e.g., CPU and memory) for the application as defined in the base configuration. For example, in cases where a first application is allocated with more resources than the resources needed by the first application, according to the current usage, a new performance profile can be defined for the first application, so that the resources are distributed to the components of the application in accordance with the current usage. The orchestrator 102 can store the performance profiles at a performance profile storage for application 360 so that the history of modified performance profiles of applications can be recorded and may be used for further analysis.

The performance optimization generator 355 can generate performance profiles to redefine configurations for one or more components (or pods) of an application so that new versions of the configurations of at least some of the pods can be defined. Based on the generated new performance profiles that are optimized based on the current usage of the applications, a new deployment, or a modification of an existing deployment of an application can be performed through the provisioning service 345.

FIG. 4A is a block diagram of an example cluster 400 running with an initial configuration at a containerized mobile network. FIG. 4B is a block diagram of the example cluster of FIG. 4A running with an updated configuration to optimize resource allocation.

FIGS. 4A and 4B present two states of the cluster 400 that are defined before and after applying a performance profile to update the initial configuration (as in FIG. 4A) to an updated configuration (as in FIG. 4B) based on a generated performance profile that adjusts the computational resources allocated to the first application 410.

The cluster 410 includes three nodes-first node 430, second node 440, and third node 450. Each node provides resources to be consumed by the running applications. Each of the nodes for example is a virtual machine that provides a 64-bit CPU and 256 GB RAM. There are two applications that are provisioned on the cluster 410—“Application 1” 410 and “Application 2” 420. The two applications each include a set of pods that are each spread on two of the three nodes. In particular, the “Application 1” 410 runs with five pods-Pod A 431, Pod B 432, Pod C 433, Pod D 441, and Pod E 442. Three of the pods, i.e., Pod A 431, Pod B 432, and Pod C 433 run on the first node 430, and the other two-Pod D 441, and Pod E 442, run on the second node 440. The “Application 2” 420 runs with three pods-Pod F 443, Pod G 451, and Pod H 452, where pod F runs on the second node 440, and the other run on the third node 450.

The applications on the cluster 400 can be provisioned according to an initial configuration defining the allocation of computational resources, where the allocation can be defined specifically for each one of the pods of each application. When performance metrics are obtained for the execution of the applications at the cluster 400, for example, the resources that are used by the application to execute their implemented logic and to provide services for received requests can be measured and used to generate a performance profile for an application.

For example, a performance profile for the “Application 1” 410 can be created by evaluating the performance metrics for one or more of the pods. If it is determined that the resources allocated to the Pod A 431, the Pod B 432, the Pod C 433, and the Pod D 441 are more than what is required in view of the current usage, as determined based on obtained metrics for performance based on provided services to subscribers, the resources allocated to each one of the pods can be adjusted to define a modified profile for the base profile (a performance profile). The performance profile can be used by a provisioning service, for example, by the provisioning service 345 of the orchestrator 102 of FIG. 3, to distribute the deployment of the pods so as to optimize the distribution and that resources provided by the underlying nodes are used in an optimal manner compared to a random distribution that does not account for aggregated resources allocated for all pods of an application in view of supplied resources by the underlying nodes.

For example, as shown on FIG. 4B, a performance profile for each of the four pods A to D, can be defined and used to deploy these pods on the first node 430. For example, the deployed instance of pods A to C can be modified to adjust the allocated resources or the instances can be redeployed with the updated configuration. The Pod D 441 as part of “Application 1” 410 can be associated with a new profile that is associated with fewer resources to be allocated to the pod so that the resources provided by the first node 430 can be sufficient to serve the needs of Pod A, Pod B, Pod C, and Pod D with their updated profiles according to the performance adjustment of the allocation of resources.

Further, for example, a performance profile for the “Application 2” 420 can be created based on evaluating the performance metrics for one or more of the pods of that application. For example, based on the evaluation, a new performance profile can be defined only for one of the pods, i.e., Pod F, so that the version of the “Application 2” 420 at the updated configuration, which is “Application 2′” 470, as shown on FIG. 4B includes three pods that have only one pod with modified allocated resources determined based on the evaluation of obtained performance metrics. The “Application 2′” can be a new version deployed for the “Application 2” 420 after the generation of the performance profile. Further, the distribution of the pods for “Application 2” 420 can be modified so as to optimize the usage of the resources by the nodes and to account for any modifications of the distributions of pods with respect to “Application 2” 410.

As such the two applications run as two new instances on the cluster 400-“Application 1′” 460 and “Application 2′” 470, that are deployed to run on the cluster 400 with performance profiles optimized to the current usage of the applications to provide services to subscribers of the containerized mobile network. For example, the configuring of the applications can be performed according to the disclosure of the process 200 of FIG. 2. The “Application 1′” 460 is updated to run with reconfigured pods that have been allocated resources as per the determined performance profile. The “Application 1′” 460 includes the Pod A′ 416 that is an updated version of the Pod A 431 and is configured to use a different set of resources that are determined according to the observed usage of the Pod A 431. The pods in the updated version, the “Application 1′” 410, are configured to run as shown on FIG. 4B and correspond to pods of the version of the “Application 1” 410 as configured to run on FIG. 4A. The pod B′ 462 corresponds to pod B 432, pod C′ corresponds to pod C′ 463, pod D 441 corresponds to pod D′ 464, where all of them after the generation of the performance profile and the allocation of the pods to pods are running on the first node 430. Pod E 442 as part of the “Application 1′” 460 corresponds (has the same configuration) to Pod E 442 and continues to run on the second node 440 as part of the “Application 1′” 460.

The “Application 2′” 470 includes the Pod F′ 472 that is an updated version of the Pod F 443 and is configured to use a different set of resources that are determined according to the observed usage of the Pod F 443. The pods in the updated version “Application 2′” 470 are configured to run as shown on FIG. 4B and correspond to pods of the “Application 2” 420 as configured to run on FIG. 4A. The pod G 451 the “Application 2” 420 corresponds to pod G 451 of “Application 2′” 470, pod H of the “Application 2” 430 corresponds to pod H 452 of “Application 2′” 470.

The modification of the configurations can be performed over several iterations to generate new performance profiles over time that are iteratively adjusted to the current usage, so as to ensure convergence to an optimal performance profile. The performance of the applications can be monitored, and modifications can be applied with adjustments of the allocated resources in a stepwise manner in order to maintain a service level expected to be provided by each of the applications, while still adjusting the resources provided. For example, a first configuration for a pod from the pods of either one of “Application 1” or “Application 2” 420 can be defined as shown in Table 1 below.

TABLE 1

| | |
|---|---|
| Parameter A | 5 CPU |
| Parameter B | 100 MB RAM memory |

A modification to the configuration can be determined as part of the generation of the performance profile based on monitoring of the usage of the pod over time, based on the current configuration as shown in Table 1. For example, to adjust the parameters A and B as shown in Table 1 to the modified configuration as shown in Table 2 below.

TABLE 2

| | |
|---|---|
| Parameter A | 5 CPU |
| Parameter B | 95 MB RAM memory |

A stability test can be performed based on obtained performance metrics for the pod to determine whether the modification of the configuration is sustainable for the current usage as measured after the modification has been applied.

Based on a determination that the new configuration with the performance profile as defined in Table 2 provides stable results, a new configuration can be determined. As such, the performance profile for the pod can be iteratively modified, for example, to the configuration as shown in Table 3 below.

TABLE 3

| | |
|---|---|
| Parameter A | 5 CPU |
| Parameter B | 90.25 (95% of 95 MB) |

Further iterative evaluation can be performed, where not only parameter B is modified, but also Parameter A is modified. The modifications can be applied and observations of the performance can be made until a performance profile that is optimal is determined. The optimal performance profile can be determined as the profile that supports performance that is steadily determined to not fall below a predefined threshold over time. When the versions of the performance profiles are analyzed, data about the performance of the services according to a given performance profile can be observed over time, and adjustments to the performance profile may be applied after determining the stable performance of a previous version of the performance profile. The modifications of the performance profiles may be limited to be performed within a certain range of acceptable values for the provided resources. For example, limits for allocating resources can be preconfigured, for example, a node may not allocate more than 80% of the CPU to one or more pods of applications. Once an optimal performance profile is determined, e.g., through iterative modifications and observation of the performance to determine a stable solution for the resource allocation, an orchestrator of the network can execute the placement of pods of the application over the nodes of the cluster so that the resources that were initially allocated according to the initial configuration can be utilized for scheduling new applications or new pods on existing nodes, thus to optimize the resource utilization.

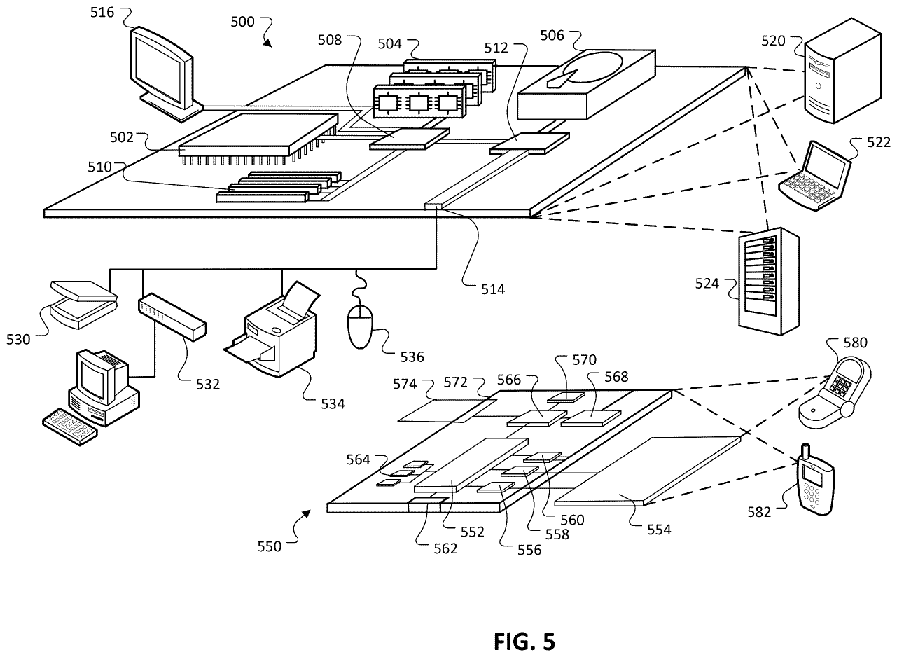

FIG. 5 shows an example of a computing device 500 and a mobile computing device 550 that are employed to execute implementations of the present disclosure. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 500 and/or the mobile computing device 550 can form at least a portion of the network environments (e.g., environment 100) described above. The computing device 500 and/or the mobile computing device 550 can also form at least a portion of the user-devices (e.g., user-device 144) described above. In some implementations, the network functions and/or network entities described above can be implemented using a cloud infrastructure including multiple computing devices 500 and/or mobile computing devices 550.

The computing device 500 includes a processor 502, a memory 504, a storage device 506, a high-speed interface 508, and a low-speed interface 512. In some implementations, the high-speed interface 508 connects to the memory 504 and multiple high-speed expansion ports 510. In some implementations, the low-speed interface 512 connects to a low-speed expansion port 514 and the storage device 504. Each of the processor 502, the memory 504, the storage device 506, the high-speed interface 508, the high-speed expansion ports 510, and the low-speed interface 512, are interconnected using various buses, and may be mounted on a common motherboard or in other manners as appropriate. The processor 502 can process instructions for execution within the computing device 500, including instructions stored in the memory 504 and/or on the storage device 506 to display graphical information for a graphical user-interface (GUI) on an external input/output device, such as a display 516 coupled to the high-speed interface 508. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of a computer-readable medium, such as a magnetic or optical disk.

The storage device 506 is capable of providing mass storage for the computing device 500. In some implementations, the storage device 506 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 502, perform one or more methods, such as those described above. The instructions can also be stored by one or more storage devices, such as computer-readable or machine-readable mediums, such as the memory 504, the storage device 506, or memory on the processor 502.

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards. In the implementation, the low-speed interface 512 is coupled to the storage device 506 and the low-speed expansion port 514. The low-speed expansion port 514, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 514 through a network adapter. Such network input/output devices may include, for example, a switch or router.

The computing device 500 may be implemented in a number of different forms, as shown in the FIG. 5. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device, such as a mobile computing device 550. Each of such devices may contain one or more of the computing device 500 and the mobile computing device 550, and an entire system may be made up of multiple computing devices communicating with each other.

The mobile computing device 550 includes a processor 552; a memory 564; an input/output device, such as a display 554; a communication interface 566; and a transceiver 568; among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate. In some implementations, the mobile computing device 550 may include a camera device(s).

The processor 552 can execute instructions within the mobile computing device 550, including instructions stored in the memory 564. The processor 552 may be implemented as a chipset of chips that include separate and multiple analog and digital processors. For example, the processor 552 may be a Complex Instruction Set Computers (CISC) processor, a Reduced Instruction Set Computer (RISC) processor, or a Minimal Instruction Set Computer (MISC) processor. The processor 552 may provide, for example, for coordination of the other components of the mobile computing device 550, such as control of user-interfaces (UIs), applications run by the mobile computing device 550, and/or wireless communication by the mobile computing device 550.

The processor 552 may communicate with a user through a control interface 558 and a display interface 556 coupled to the display 554. The display 554 may be, for example, a Thin-Film-Transistor Liquid Crystal Display (TFT) display, an Organic Light Emitting Diode (OLED) display, or other appropriate display technology. The display interface 556 may include appropriate circuitry for driving the display 654 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a Single in Line Memory Module (SIMM) card interface. The expansion memory 574 may provide extra storage space for the mobile computing device 550, or may also store applications or other information for the mobile computing device 550. Specifically, the expansion memory 574 may include instructions to conduct or supplement the processes described above, and may include secure information also. Thus, for example, the expansion memory 574 may be provided as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 552, perform one or more methods, such as those described above. The instructions can also be stored by one or more storage devices, such as one or more computer-readable or machine-readable mediums, such as the memory 564, the expansion memory 574, or the memory on the processor 552. In some implementations, the instructions can be received in a propagated signal, such as, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS), IP Multimedia Subsystem (IMS) technologies, and 5G technologies. Such communication may occur, for example, through the transceiver 568 using a radio frequency. In addition, short-range communication, such as using a Bluetooth or Wi-Fi, may occur. In addition, a Global Positioning System (GPS) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.), and may also include sound generated by applications operating on the mobile computing device 550.

The mobile computing device 550 may be implemented in a number of different forms, as shown in FIG. 5. For example, it may be implemented in the user-device described with respect to FIG. 1A. Other implementations may include a phone device 580, a personal digital assistant 582, and a tablet device (not shown). The mobile computing device 550 may also be implemented as a component of a smart-phone, AR device, or other similar mobile device.

The computing device 500 may be implemented in the network environment 100 described above with respect to FIGS. 1-5.

Computing devices 500 and/or 550 can also include USB flash drives. The USB flash drives may store operating systems and other applications. The USB flash drives can include input/output components, such as a wireless transmitter or USB connector that may be inserted into a USB port of another computing device.

Other embodiments and applications not specifically described herein are also within the scope of the following claims. Elements of different implementations described herein may be combined to form other embodiments.

What is claimed is:

1. A computer-implemented method comprising:
receiving, at one or more computing devices controlling nodes running in clusters on a containerized mobile network, performance metrics associated with a first application of a plurality of applications running on the containerized mobile network, wherein the first application is deployed on one or more nodes of a first cluster of the containerized mobile network in accordance with an initial configuration indicative of computational resources allocated to the first application;
generating, based on the performance metrics, a performance profile associated with the first application, the performance profile defining computational resources to be allocated to the first application based on a current usage of the first application to provide services to subscribers of the containerized mobile network; and
providing, by the one or more computing devices, an instruction to update the initial configuration for the first application in accordance with the performance profile to adjust the computational resources allocated to the first application according to the performance profile.

2. The method of claim 1, wherein generating the performance profile associated with the first application comprises:
determining computational resources required by each of a plurality of components of the first application based on the current usage of the first application, wherein each component is deployed and runs on a node of the one or more nodes of the first cluster associated with the first application; and
defining the performance profile for the first application for adjusting the computational resources allocated to each component in accordance with the required computational resources as determined.

3. The method of claim 1, comprising:
determining, by the one or more computing devices, available computational resources at a first node to be allocated to another component of an application of the plurality of applications; and
in response to determining the available computational resources at the first node, identifying, by the one or more computing devices, a component of the application to be scheduled for deploying on the first node to consume at least some of the available computation resources as determined to be allocated to the other component;
sending instructions to remove the component from a second node of the first cluster of the containerized mobile network; and
sending instructions to deploy the component on the first node, wherein the component is deployed on the first node according to a current configuration of the application including the component, wherein the current configuration of the application includes a performance profile of the component defining computational resources to be allocated to the component of the application by the first node.

4. The method of claim 3, wherein the component is of the first application, and wherein the current configuration for the component defines the computational resources to be allocated to the component in accordance with the current usage of the first application.

5. The method of claim 3, wherein the component is of a second application being deployed and running at the first cluster, wherein the first and the second application include components deployed on the same first node of the first cluster.

6. The method of claim 1, comprising:
continuously monitoring and evaluating the performance metrics of the first application while running on the containerized mobile network; and
iteratively generating one or more subsequent performance profiles associated with the first application to generate configurations to be used for updating the first application thus to adjust the computational resources allocated to the first application in accordance with the current usage of the first application as determined based on the continuous monitoring and evaluation of the performance metrics of the first application,
wherein the configurations are indicative of computational resources to be allocated to the first application as defined with a respective performance profile.

7. The method of claim 1, wherein the computational resources provided by the one or more nodes of the first cluster include CPU and memory resource.

8. The method of claim 1, wherein each cluster on the containerized mobile network comprises a set of nodes that run containerized applications, wherein each cluster runs a networking application deployed on at least one node of the respective cluster, and wherein the networking application encapsulates physical and virtual resources.

9. The method of claim 1, comprising:
persisting one or more latest-used configurations for the first application while monitoring the performance metrics of the first application running on the containerized mobile network.

10. A system comprising:
one or more processors; and
one or more computer-readable memories coupled to the one or more processors and having instructions stored thereon that are executable by the one or more processors to perform operations comprising:
receiving, at one or more computing devices controlling nodes running in clusters on a containerized mobile network, performance metrics associated with a first application of a plurality of applications running on the containerized mobile network, wherein the first application is deployed on one or more nodes of a first cluster of the containerized mobile network in accordance with an initial configuration indicative of computational resources allocated to the first application;
generating, based on the performance metrics, a performance profile associated with the first application, the performance profile defining computational resources to be allocated to the first application based on a current usage of the first application to provide services to subscribers of the containerized mobile network; and
providing, by the one or more computing devices, an instruction to update the initial configuration for the first application in accordance with the performance profile to adjust the computational resources allocated to the first application according to the performance profile.

11. The system of claim 10, wherein generating the performance profile associated with the first application comprises:
determining computational resources required by each of a plurality of components of the first application based on the current usage of the first application, wherein each component is deployed and runs on a node of the one or more nodes of the first cluster associated with the first application; and
defining the performance profile for the first application for adjusting the computational resources allocated to each component in accordance with the required computational resources as determined.

12. The system of claim 10, wherein the one or more computer-readable memories coupled to the one or more processors further store instructions executable by the one or more processors to perform operations comprising:
determining, by the one or more computing devices, available computational resources at a first node to be allocated to another component of an application of the plurality of applications; and
in response to determining the available computational resources at the first node, identifying, by the one or more computing devices, a component of the application to be scheduled for deploying on the first node to consume at least some of the available computation resources as determined to be allocated to the other component;
sending instructions to remove the component from a second node of the first cluster of the containerized mobile network; and
sending instructions to deploy the component on the first node, wherein the component is deployed on the first node according to a current configuration of the application including the component, wherein the current configuration of the application includes a performance profile of the component defining computational resources to be allocated to the component of the application by the first node.

13. The system of claim 12, wherein the component is of the first application, and wherein the current configuration for the component defines the computational resources to be allocated to the component in accordance with the current usage of the first application.

14. The system of claim 12, wherein the component is of a second application being deployed and running at the first cluster, wherein the first and the second application include components deployed on the same first node of the first cluster.

15. The system of claim 12, wherein the one or more computer-readable memories coupled to the one or more processors further store instructions executable by the one or more processors to perform operations comprising:
continuously monitoring and evaluating the performance metrics of the first application while running on the containerized mobile network; and
iteratively generating one or more subsequent performance profiles associated with the first application to generate configurations to be used for updating the first application thus to adjust the computational resources allocated to the first application in accordance with the current usage of the first application as determined based on the continuous monitoring and evaluation of the performance metrics of the first application,
wherein the configurations are indicative of computational resources to be allocated to the first application as defined with a respective performance profile.

16. A non-transitory computer-readable medium storing instructions that are executable by a processing device, and upon such execution cause the processing device to perform operations comprising:
receiving, at one or more computing devices controlling nodes running in clusters on a containerized mobile network, performance metrics associated with a first application of a plurality of applications running on the containerized mobile network, wherein the first application is deployed on one or more nodes of a first cluster of the containerized mobile network in accordance with an initial configuration indicative of computational resources allocated to the first application;
generating, based on the performance metrics, a performance profile associated with the first application, the performance profile defining computational resources to be allocated to the first application based on a current usage of the first application to provide services to subscribers of the containerized mobile network; and
providing, by the one or more computing devices, an instruction to update the initial configuration for the first application in accordance with the performance profile to adjust the computational resources allocated to the first application according to the performance profile.

17. The computer-readable medium of claim 16, wherein generating the performance profile associated with the first application comprises:
determining computational resources required by each of a plurality of components of the first application based on the current usage of the first application, wherein each component is deployed and runs on a node of the one or more nodes of the first cluster associated with the first application; and
defining the performance profile for the first application for adjusting the computational resources allocated to each component in accordance with the required computational resources as determined.

18. The computer-readable medium of claim 16, comprising:
determining, by the one or more computing devices, available computational resources at a first node to be allocated to another component of an application of the plurality of applications; and
in response to determining the available computational resources at the first node, identifying, by the one or more computing devices, a component of the application to be scheduled for deploying on the first node to consume at least some of the available computation resources as determined to be allocated to the other component;
sending instructions to remove the component from a second node of the first cluster of the containerized mobile network; and
sending instructions to deploy the component on the first node, wherein the component is deployed on the first node according to a current configuration of the application including the component, wherein the current configuration of the application includes a performance profile of the component defining computational resources to be allocated to the component of the application by the first node.

19. The computer-readable medium of claim 18, wherein the component is of the first application, and wherein the current configuration for the component defines the computational resources to be allocated to the component in accordance with the current usage of the first application.

20. The computer-readable medium of claim 18, wherein the component is of a second application being deployed and running at the first cluster, wherein the first and the second application include components deployed on the same first node of the first cluster.
